(19) United States
(12) Patent Application Publication
(10) Pub. No.: US 2012/0159339 A1
(43) Pub. Date: Jun. 21, 2012

(54) METHOD FOR FACILITATING SELECTION OF OBJECTS APPEARING IN A USER INTERFACE OF A WIRELESS CONTROL SYSTEM

(75) Inventor: HSIU YUN CHIANG, HSINCHU COUNTY (TW)

(73) Assignee: RALINK TECHNOLOGY CORPORATION, HSINCHU COUNTY (TW)

(21) Appl. No.: 13/116,402

(22) Filed: May 26, 2011

Related U.S. Application Data
(60) Provisional application No. 61/425,227, filed on Dec. 20, 2010.

(51) Int. Cl. G06F 3/01; G06F 15/16

(52) U.S. Cl. 715/738

(57) ABSTRACT

A method for facilitating selection of objects appearing in a window of a user interface of a wireless control system comprises the steps of: displaying a plurality of client objects in a first connection layer of a first interface; moving the displayed client objects in the first connection layer; selecting a client object from the plurality of client objects in the first connection layer; displaying a plurality of client objects in a second connection layer if the selected client object in the first connection layer connects to client objects in a second connection layer; and establishing the network connection with the selected client object in the first connection layer.

### BACKGROUND OF THE INVENTION

1. Field of the Invention

The current disclosure relates to a method for facilitating selection between objects appearing in a user interface and, in particular, to a graphical user interface (GUI) for wireless connection systems.

2. Description of the Related Art

In current computer interfaces of wireless connection interface, list view is widely used for representing available clients. FIG. 1 illustrates the conventional interface of wireless connection system. The conventional interface provides list view of the available access points (APs). Users need to scroll up and down to search for available wireless APs with proper signal strength for requesting a wireless connection.

This causes inconvenience to users looking for preferred clients with proper signal strength, since list view provides a cluttered presentation and confuses the user while selecting preferred client objects. Moreover, with the rapid development in wireless communication technology, the current computer human interface of wireless connection system is not able to fulfill the requirements of new generation wireless communication protocols such as Wi-Fi Direct, a peer-to-peer (P2P) technology. Such new generation wireless communication protocols provide connections of AP devices, connections of AP-like devices, and connections of sub-layer wireless devices. The sub-layer devices are defined as the wireless devices connecting to the AP devices or AP-like devices. The conventional interface of a wireless connection system is not able to display the connection of sub-layer wireless device. Therefore, there is a need for a method for facilitating selection between objects appearing in a computer GUI of wireless connection system having features of easy selection and displaying sub-layer client objects.

### SUMMARY OF THE INVENTION

The object of the present invention is to provide a selection method of a GUI of a wireless connection system having features of rotary selection and displaying client objects in two layers. The present invention is limited to a specific apparatus, that is, a wireless control system, and thus provides a physical transformation of the specific apparatus.

In accordance with one embodiment of the present invention, the method comprises the following steps: displaying a plurality of client objects in a first connection layer of a first interface, wherein the plurality of client objects in the first connection layer are displayed in a circular manner and the displayed client objects in the first connection layer are rotated by rotating a wheel on a mouse or sliding a finger on a touch screen; allowing the user to select a preferred client object from the plurality of client objects in the first connection layer by clicking a mouse button, wherein the selected client object will be moved to a predetermined position of the circularly disposed client objects; and displaying the client objects in a second connection layer if the selected client object connects to client objects in the second connection layer. The client objects in the second connection layer can also be rotated by rotating the wheel on the mouse or by sliding a finger on the touch screen. The wireless connection is then established with the selected client object in the first connection layer; the system provides a pop-up message window. The pop-up message window provides the connection type with selections of security authentication, selections of operation channel and selections of profile information.

In accordance with one embodiment of the present invention, the method comprising the following steps: displaying a plurality of client objects in a first connection layer of a first interface, wherein the plurality of client objects in the first connection layer are displayed in a circular manner; rotating the displayed client objects until a preferred client object is moved into a middle position of the circularly displayed client objects, wherein the client object moved into the middle position of the circularly displayed client object is a preferred client object; and allowing the user to select the client object at the middle position of the circularly displayed client objects in the first connection layer.

The client objects in the second connection layer can also be rotated by rotating a mouse wheel or by sliding a finger on the touch screen. A wireless connection is then established with the selected client object in the first connection layer while providing a pop-up message. The pop-up message window provides the connection type with options of security authentication, options of operation channel and profile information.

In order to have further understanding of the techniques, means, and effects of the current disclosure, the following detailed description and drawings are hereby presented, such that the purposes, features and aspects of the current disclosure may be thoroughly and concretely appreciated; however, the drawings are provided solely for reference and illustration, without any intention to be used for limiting the current disclosure.

### BRIEF DESCRIPTION OF THE DRAWINGS

FIG. 1 illustrates the conventional interface of wireless connection systems;

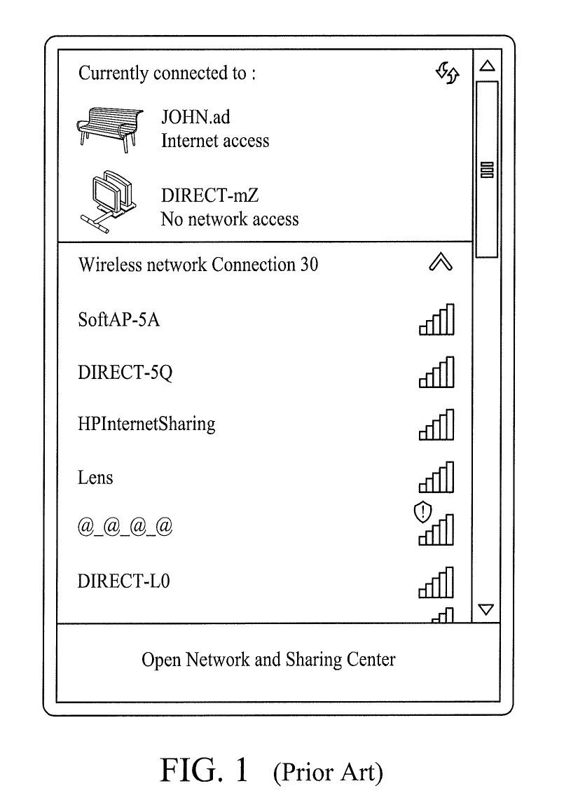

FIG. 2 illustrates the interface schematic in accordance with one embodiment of the present invention;

FIG. 3A illustrates the step of rotating the circularly displayed client objects by rotating up a mouse wheel or by sliding a finger up on the touch screen;

FIG. 3B illustrates the step of rotating the circularly displayed client objects by rotating down a mouse wheel or by sliding a finger down on the touch screen;

FIG. 4 illustrates a first connection layer and a second connection layer in a second interface;

FIG. 5 illustrates the interface schematic in accordance with one embodiment of the present invention;

FIG. 6A illustrates the step of rotating the circularly displayed client objects by rotating up the mouse wheel or by sliding a finger up on the touch screen;

FIG. 6B illustrates the step of rotating the circularly displayed client objects by rotating down the mouse wheel or by sliding a finger down on the touch screen;

FIG. 7 illustrates a first connection layer and a second connection layer in a second interface in accordance with one embodiment of the present invention;

FIG. 8 is a flowchart of the selection method in accordance with one embodiment of the present invention; and

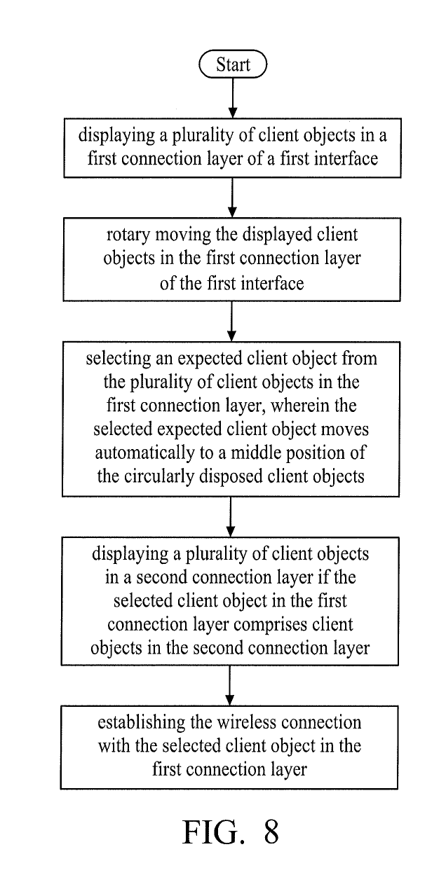

FIG. 9 is a flowchart of the selection method in accordance with one embodiment of the present invention.

### DETAILED DESCRIPTION OF THE INVENTION

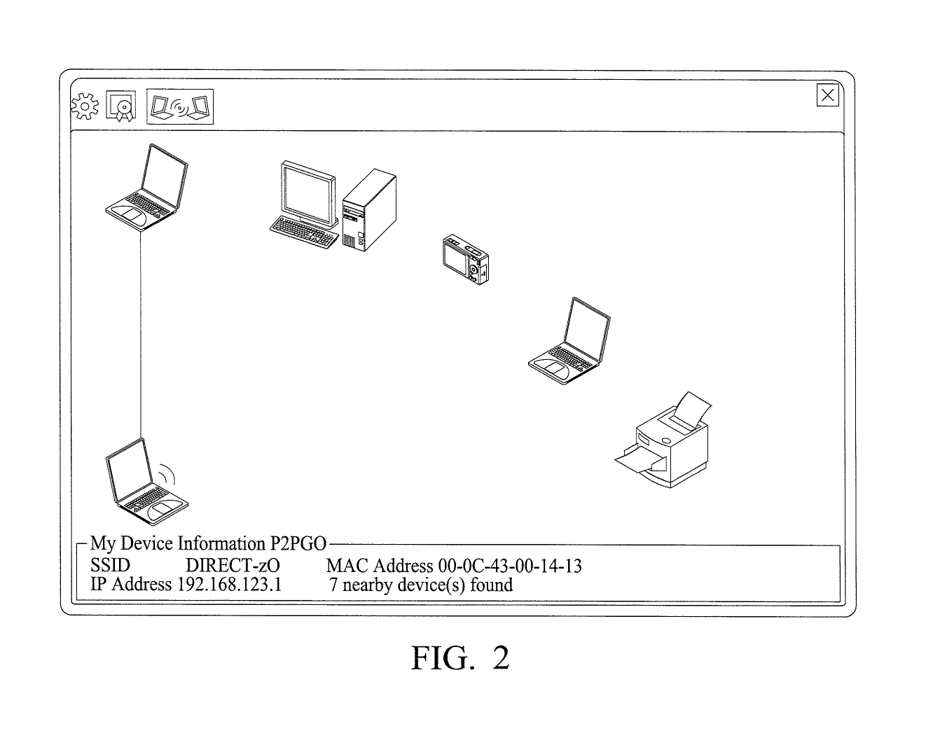

In order to explain the method for facilitating selection of objects appearing in a computer interface of the present invention more clearly, a bus architecture that utilizes the method of the present invention will be disclosed thereinafter. FIG. 2 shows one embodiment of the present invention indicating a first interface with a first connection layer. One or a plurality of client objects are scanned and circularly displayed on the first interface around an object with wireless connection request, wherein some of the available client objects are not shown in the first interface. Since each of the objects is represented by its own GUI, users are able to recognize those client objects.

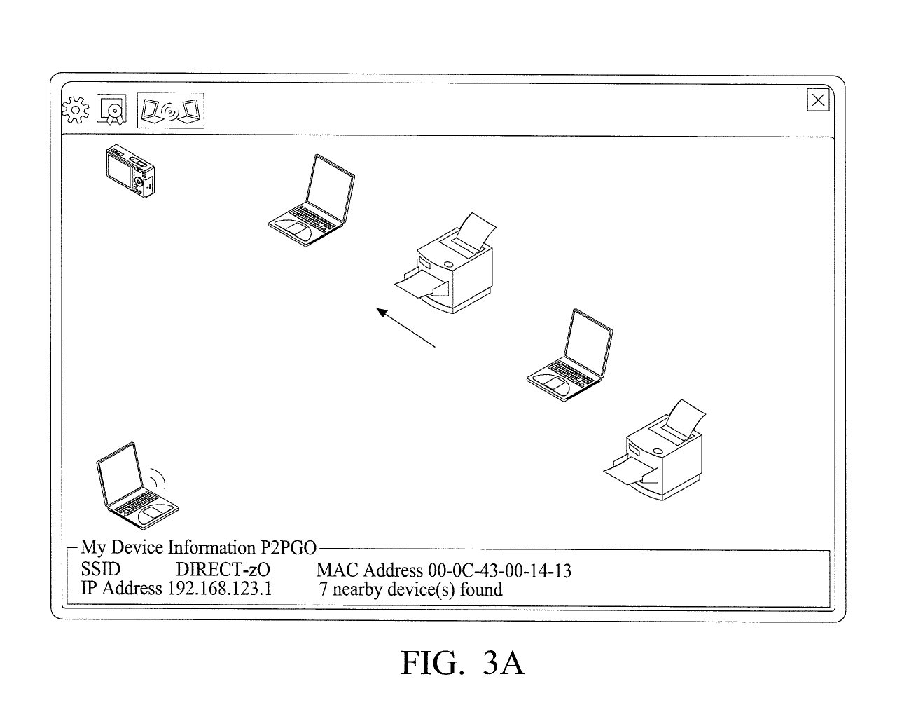

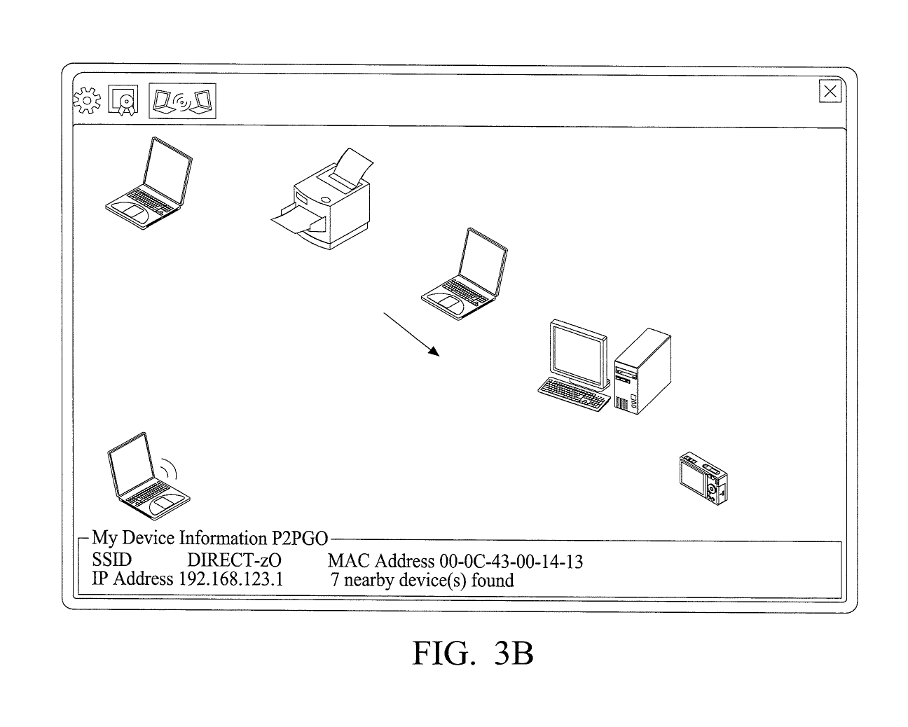

FIG. 3A shows the control of the upward rotation of the circularly displayed client objects by either upward rotation of a mouse wheel or by upward sliding of a finger on a touch screen. Similarly, FIG. 3B shows the downward rotation of the circularly displayed client objects by downward rotation of the mouse wheel or by downward sliding of a finger on the touch screen. With such a system, users would not confuse about selection of the preferred client object.

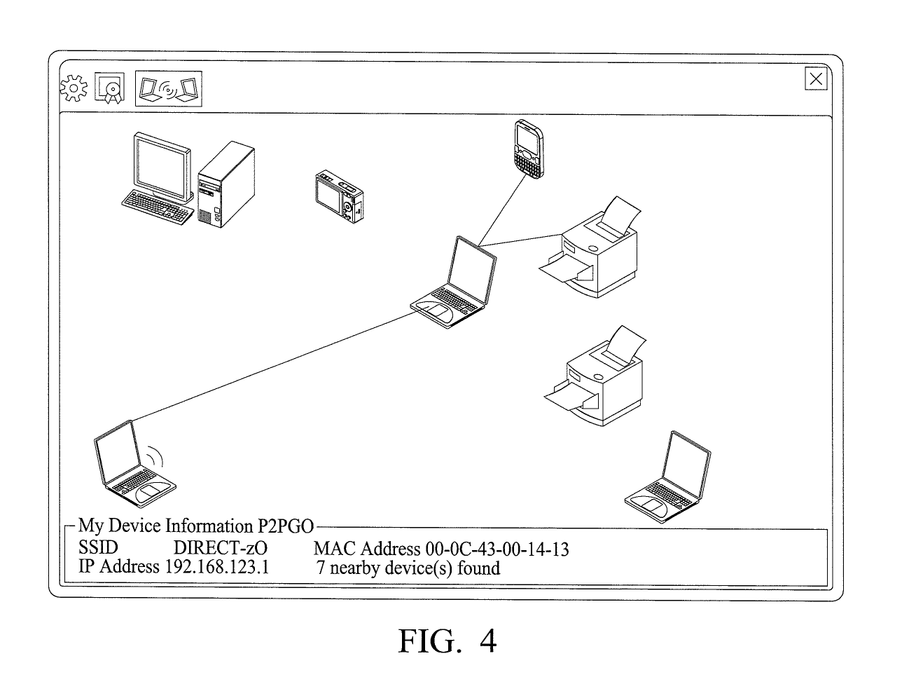

FIG. 4 shows the first connection layer and a second connection layer in a second interface. When the user selects a preferred client object, the selected client object is moved to a predetermined position of the circularly displayed client objects. If the selected client object connects to one or a plurality of client objects in the second connection layer, such client objects in the second connection layer will be circularly displayed in the second interface. The client objects in the second connection layer are also circularly displayed. The client objects in the second connection layer can be rotated up or down by rotating the mouse wheel up or down or by sliding a finger up or down on the touch screen. FIG. 4 also indicates the establishment of a connection between the object with wireless connection request and the selected client object in the first connection layer.

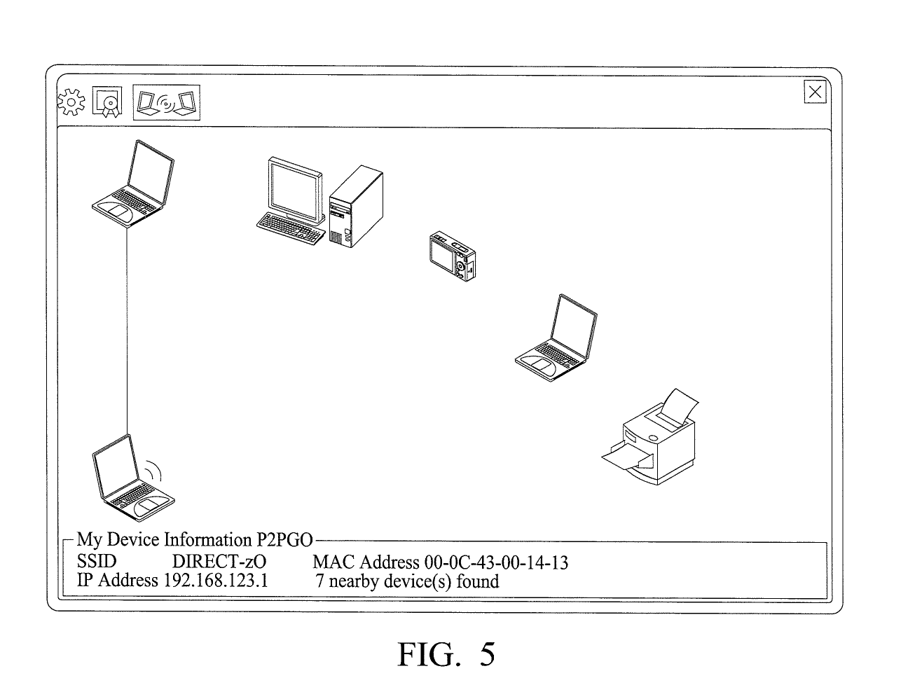

In the step of establishing the wireless connection between the object with wireless connection request and the selected client object in the first connection layer, a pop-up message window provides the connection type with options of configuration method, options of operating channel and options of profile information. FIG. 5 shows a flowchart of the embodiment of the present invention.

FIG. 5 illustrates one embodiment of the present invention indicating a first interface with a first connection layer. One or a plurality of client objects are scanned and circularly displayed on a first interface around an object with wireless connection request wherein some of the available client objects are not shown in the interface. Since each of the objects is represented by its own GUI, users are able to recognize client objects.

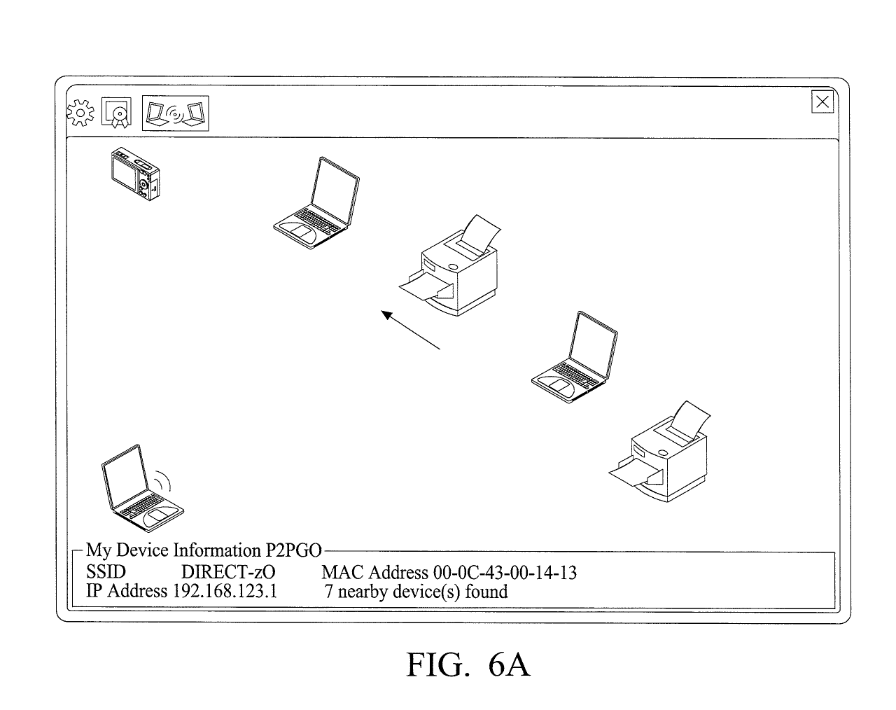

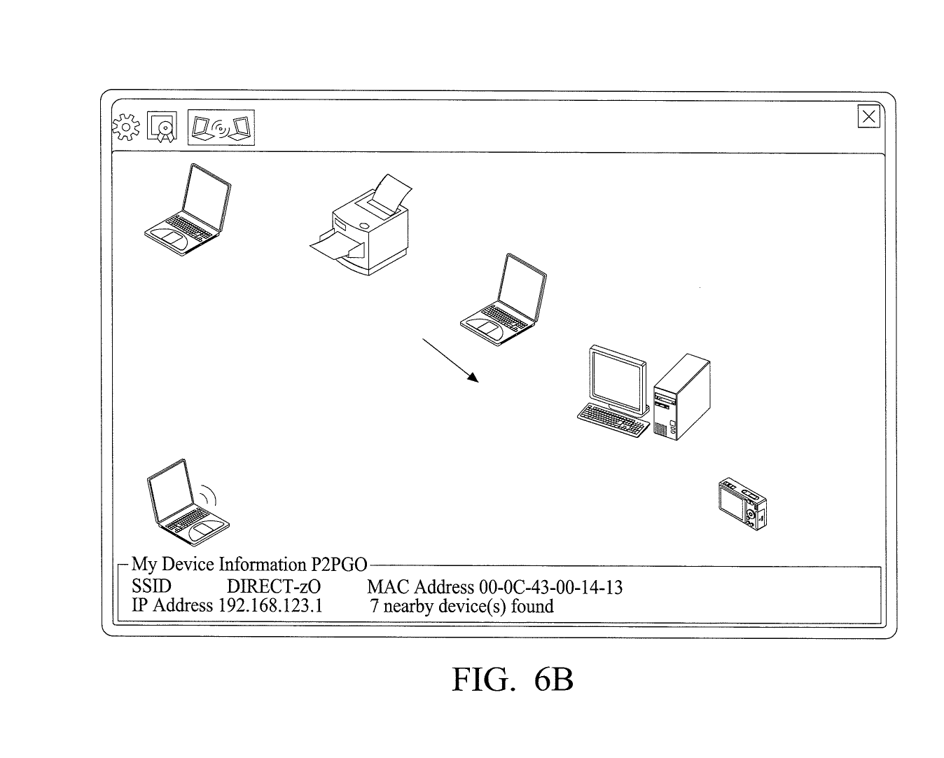

FIG. 6A shows the control of the upward rotation of the circularly displayed client objects by upward rotation of a mouse wheel or by upward sliding of a finger on the touch screen. Similarly, FIG. 6B shows the control of the downward rotation of the circularly disposed client objects by downward rotation of the mouse wheel or by downward sliding of a finger on the touch screen. With such a system, users would not confuse about selection the preferred client object.

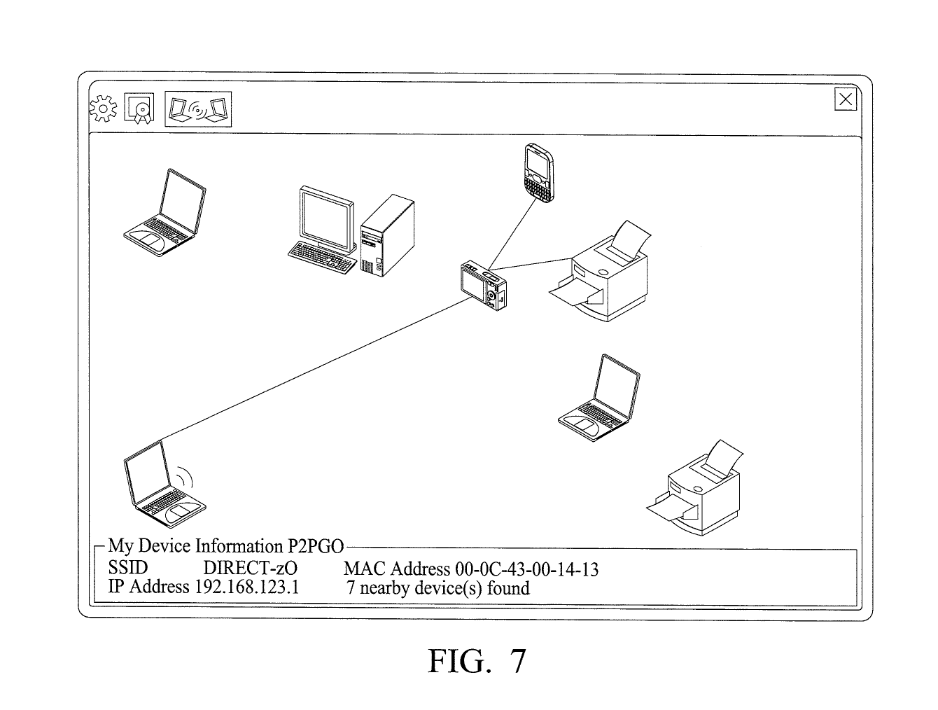

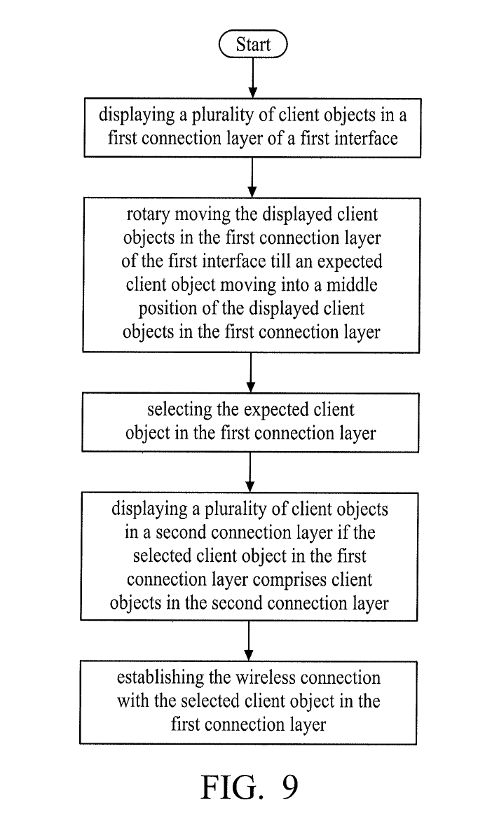

FIG. 7 shows the first connection layer and a second connection layer in a second interface. To select the preferred client object, users need to rotate the client list up or down until the preferred client object moves into the middle position of the circularly displayed client objects. If the selected client object includes one or a plurality of client objects in the second connection layer, such client objects of the second connection layer will be circularly displayed in the second interface. The client objects in the second connection layer are also circularly disposed, and can be rotated up or down by rotating the mouse wheel up or down or by sliding a finger up or down on the touch screen. FIG. 7 also indicates the establishment of a connection between the object with wireless connection request and the selected client object in the first connection layer. FIG. 9 is a flowchart of the embodiment of the present invention.

While establishing the wireless connection between the object with wireless connection request and the selected client object in the first connection layer, the system provides a pop-up message window showing the connection type with options of configuration method, options of operating channel and profile information.

Although the present invention and its objectives have been described in detail, it should be understood that various changes, substitutions and alterations can be made herein without departing from the spirit and scope of the invention as defined by the appended claims. For example, many of the processes discussed above can be implemented using different methodologies, replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for facilitating selection of client objects in a network, comprising the steps of:
displaying a plurality of client objects in a first connection layer of a first interface;
selecting a client object from the plurality of client objects in the first connection layer, wherein the selected client object is then moved to a predetermined position;
displaying a plurality of client objects in a second connection layer of a second to interface if the selected client object in the first connection layer connects to client objects in a second connection layer; and
establishing the network connection with the selected client object in the first connection layer.

2. The method of claim 1, wherein the step of displaying the plurality of client objects in the first connection layer is circularly displaying the plurality of client objects in the first connection layer around an object with wireless connection request.

3. The method of claim 1, wherein the step of selecting a client object from the plurality of client objects in the first connection layer is achieved by rotating the mouse wheel or by sliding a finger on a touch screen.

4. The method of claim 1, wherein the step of displaying the client objects in the second connection layer is circularly displaying the client objects in the second connection layer around the selected client object.

5. The method of claim 1, wherein the step of establishing the network connection includes providing a pop-up message window.

6. The method of claim 1, wherein the step of establishing the network connection includes connecting to the client objects in the second connection layer.

7. The method of claim 5, wherein the pop-up message window includes options of security authentication, options of operating channel, and profile information.
